(19) United States
(12) Patent Application Publication
(10) Pub. No.: US 2026/0064156 A1
(43) Pub. Date: Mar. 5, 2026

(54) COVER AND DOCK FOR MOBILE ELECTRONIC DEVICE

(71) Applicant: Havis, Inc., Warminster, PA (US)

(72) Inventors: Keith Halonen, Howell, MI (US); Stephen Telesco, Dexter, MI (US); Chris Buttenob, Warminster, PA (US); Justin Salamon, Warminster, PA (US)

(73) Assignee: Havis, Inc., Warminster, PA (US)

(21) Appl. No.: 19/311,216

(22) Filed: Aug. 27, 2025

Related U.S. Application Data
(60) Provisional application No. 63/687,456, filed on Aug. 27, 2024.

(51) Int. Cl. G06F 1/16

(52) U.S. Cl. CPC G06F 1/1632; G06F 1/166

(57) ABSTRACT

A mounting system for a mobile electronic device includes a cover and an apparatus for mounting the mobile electronic device received within the cover. The cover includes a first main surface with one or more latching points. The apparatus includes a base having a mounting surface including one or more latches and a docking surface projecting from and fixedly coupled to the mounting surface. The docking connector is coupled to the docking surface and is configured to electrically connect with electrical contacts of the cover. When the docking connector is electrically connected with the electrical contacts, the first main surface is positioned obliquely relative to the mounting surface in a first position of the docking connector, and the first main surface is aligned in contact with the mounting surface in the second position of the docking connector, so one or more latches mate with the one or more latching points.

### CROSS-REFERENCE TO RELATED APPLICATIONS

This application claims priority to U.S. patent application Ser. No. 63/687,456, entitled COVER AND DOCK FOR MOBILE ELECTRONIC DEVICE, filed Aug. 27, 2024, the contents of which are incorporated herein by reference.

### TECHNICAL FIELD

The present invention relates generally to covers and docks for mobile electronic devices.

### BACKGROUND

Specialized vehicles are an essential tool in many different professions. For example, professions such as law enforcement commonly utilize a number of specialized electronic apparatuses (e.g., computers, radio systems, sirens) that are not found in conventional automobiles. Other professions and enterprises also commonly have a need to use vehicles with similar specialized equipment. For example, customized electronics apparatuses are frequently installed in vehicles such as forklifts, waste collection trucks, utility trucks, construction equipment and agricultural equipment. While vehicles may be specially manufactured to include these apparatuses, these apparatuses may also be added to conventional automobiles or other vehicles through after-market installations. This is particularly true in the context of law enforcement vehicles, because these vehicles are usually based on conventional road vehicles, and each vehicle can require unique customizations depending upon the particular requirements of the jurisdiction or purpose.

While vehicles are commonly fitted with custom electronics and other equipment, it can be problematic to install such devices in a simple and effective manner. For example, conventional vehicle interior cabins may lack equipment that provides suitable mechanical and/or electrical interfaces for specialized electronic apparatuses. This leads to irregular and relatively inefficient mounting of such devices, as well as inability to maintain specialized electronic apparatuses or equipment in safe and reliable functioning condition.

There remains a need to provide alternative docking stations configured to mount specialized electronic apparatuses or equipment in vehicles, and particularly for retrofitting existing vehicles to include specialized electronic apparatuses or equipment.

### SUMMARY

Aspects of the present invention are directed to a mounting system for a mobile electronic device.

In one exemplary aspect, there is provided a mounting system for a mobile electronic device. The mounting system includes a cover configured to house the mobile electronic device and an apparatus for mounting the mobile electronic device received within a cover. The cover includes a first main surface comprising one or more latching points; one or more peripheral side surfaces at least partially surrounding the first main surface; at least one electrical connector configured to connect with an electrical connector of the mobile electronic device; and one or more electrical contacts mounted on at least one of the one or more peripheral side surfaces, the one or more electrical contacts in communication with the at least one electrical connector. The apparatus for mounting the mobile electronic device received within the cover includes a base and a docking connector. The base includes a mounting surface configured to face the first main surface and a docking surface projecting from and fixedly coupled to the mounting surface. The mounting surface has one or more latches configured to mate with the one or more latching points and the docking surface is configured to face the at least one of the one or more peripheral side surfaces of the cover. The docking connector is coupled to the docking surface and the docking connector is configured to electrically connect with the one or more electrical contacts of the cover. The docking connector is movable relative to the docking surface between a first position and a second position. When the docking connector is electrically connected with the one or more electrical contacts, the first main surface of the cover is positioned obliquely relative to the mounting surface in the first position of the docking connector, and the first main surface of the cover is aligned in contact with the mounting surface in the second position of the docking connector, such that the one or more latches mate with the one or more latching points.

In some exemplary aspects, the apparatus includes one or more biasing elements in order to bias the docking connector toward the first position. In some exemplary aspects, the docking connector is mounted on a docking platform, the docking platform being pivotable relative to the docking surface to move the docking connector between the first and second positions. In some exemplary aspects, the docking platform includes a stop surface positioned to engage a portion of the docking surface when the docking connector is in the first position.

In some exemplary aspects, the apparatus has at least one actuator configured to disengage the one or more latches from the one or more latching points. In some exemplary aspects, the actuator is a handle coupled to a region of the base opposite the docking surface. In some exemplary aspects, the apparatus also includes a lock for controlling actuating of the handle to latch or unlatch the one or more latches.

In some exemplary aspects, the first main surface of the cover includes at least one electrical receptacle separate from the one or more electrical contacts. In some exemplary aspects, the at least one electrical receptacle is in communication with the at least one electrical connector. In some exemplary embodiments, the at least one electrical receptacle is mounted on a common circuit board with the one or more electrical contacts.

In some exemplary aspects, the one or more electrical contacts are one or more rows of pogo pads formed on the at least one of the one or more peripheral side surfaces. In some exemplary aspects, the one or more rows of pogo pads are formed flush with the at least one of the one or more peripheral side surfaces.

In some exemplary aspects, the first main surface of the cover comprises a stand in order to maintain the mobile electronic device in an upright or tilted position. In some exemplary aspects, the stand is configured to be stowed against the first main surface to enable mounting of the cover to the apparatus.

In some exemplary aspects, the cover comprises a plurality of bumpers positioned at respective corners of the one or more peripheral side surfaces of the cover. One or more of the bumpers may include an attachment point for attaching one or more accessories to the cover.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be omitted. In addition, according to common practice, the various features of the drawings are not drawn to scale unless otherwise indicated, and the dimensions of the various features may be expanded or reduced for clarity. Included in the drawings are the following figures:

FIG. 1 shows an example of a mounting system for a mobile electronic device, including a cover configured to house the mobile electronic device and an apparatus for mounting the mobile electronic device received within the cover.

FIGS. 2A-2C shows an example of an apparatus for receiving a mobile electronic device received within an example protective cover.

FIGS. 3A-3E show an example docking sequence of the apparatus of FIGS. 2A-2C.

FIGS. 4A-4C show cross-sectional views of the example docking sequence of FIGS. 3A-3E.

FIG. 5 shows a front view of an example cover for a mobile electronic device.

FIGS. 6A and 6B show a rear perspective view of the cover of FIG. 5.

FIG. 7 shows an example of the internal electronics of the apparatus of FIGS. 2A-2C.

FIG. 8 shows an example of the internal electronics of the cover of FIG. 5.

FIGS. 9A and 9B show an example electrical connection to the mobile electronic device housed in the cover of FIG. 5.

### DETAILED DESCRIPTION

The systems and apparatuses disclosed herein are usable to provide coverage, protection, and mounting for mobile electronic devices. Aspects of the disclosed examples are usable in any application in which a mount is desired.

The disclosed examples may be configured for and used with any type of mobile device that would benefit from a protective cover. While any objects may be mounted to the disclosed examples, the disclosed mounting apparatuses are particularly suitable for mounting electronic devices, such as laptops, tablets, phones, radios, or the like. Other electronic devices or objects mountable with the disclosed apparatuses will be known to those of ordinary skill in the art from the description herein. The mounting apparatuses may be configured to hold the device in a fixed position, or to allow the device to move (e.g., rotate, pivot, etc.) between various positions (e.g., use and stowed positions, to accommodate user preferences, etc.).

The disclosed mounting apparatus examples may be configured to provide electrical communication while the mobile electronic device is mounted. Such electrical communication may be used for charging, for data communication, or both. The disclosed mounting apparatus examples may be configured to electrically interconnect directly with the mobile electronic device housing in the cover, or may electrically interconnect indirectly with the mobile electronic device via electrical contacts or components on the cover.

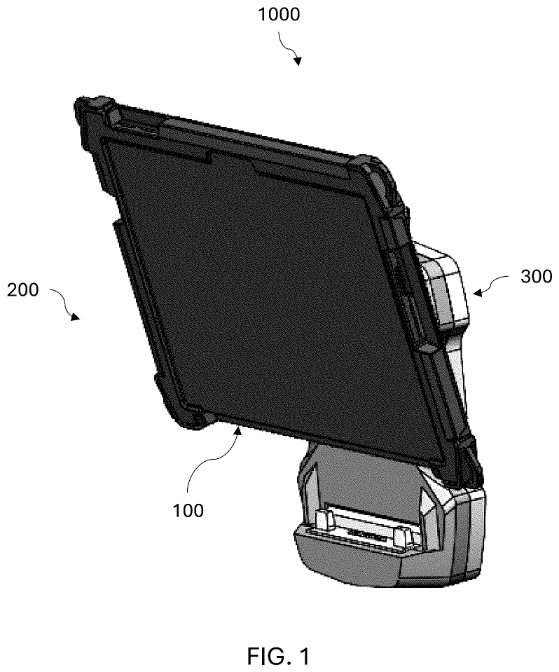

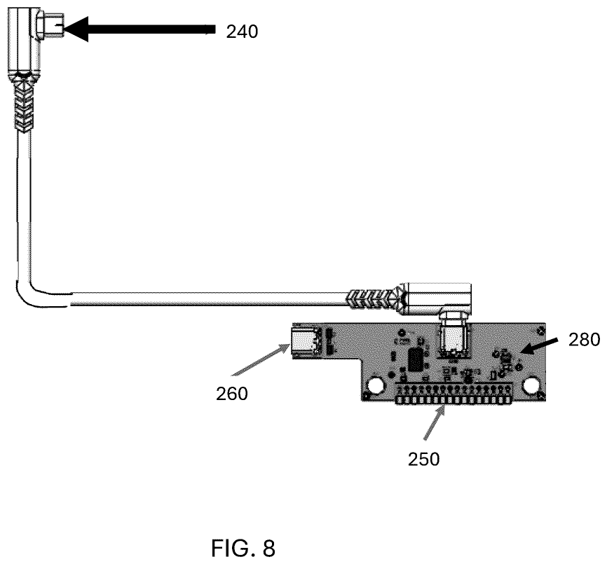

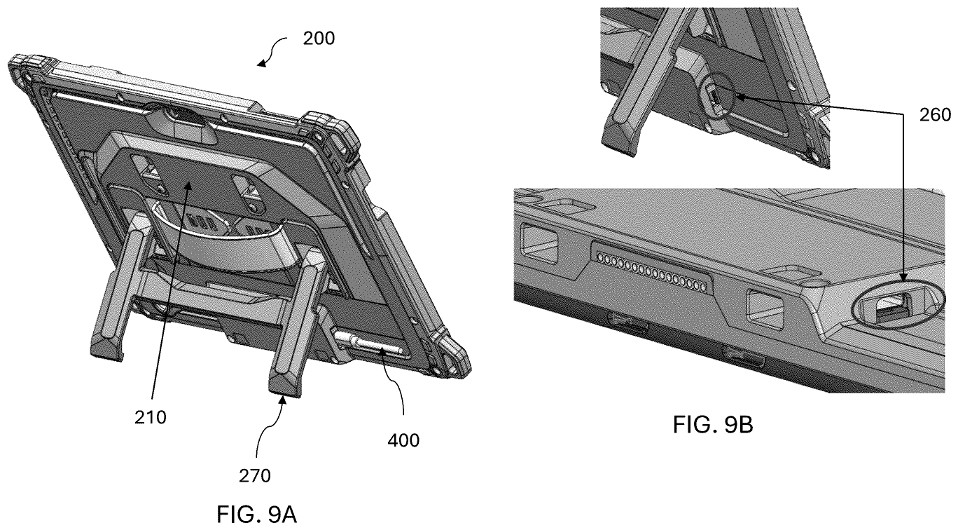

With reference to the drawings, FIG. 1 illustrates an example of a mounting system 1000 for a mobile electronic device 100, showing a cover 200 configured to house the mobile electronic device 100 and an apparatus 300 for mounting the mobile electronic device 100 received within the cover 200. In an exemplary embodiment, the system 1000 includes the cover 200 as illustrated in FIGS. 8 and 9A-9B. The cover 200 includes a first main surface 210 having one or more latching points 220. Additionally or optionally, the first main surface 210 of the cover 200 has at least one electrical receptacle 260. In a non-limiting example, the first main surface 210 of the cover 200 includes a stand 270 (FIG. 9A) in order to maintain the mobile electronic device in an upright or tilted position. A hand strap 272 may be provided on the first main surface 210 of the cover 200 to facilitate handling of at least the cover 200. Additional functionalities of the mobile electronic device 100 may be facilitated by openings 274 (e.g., for operation of rear camera of the mobile electronic device 100), 276 (e.g., for holding a stylus associated with the mobile electronic device 100), 278 (e.g., for accessing power or volume buttons or other buttons or ports on device 100) or other openings defined on the first main surface 210 of the cover 200. Additionally or optionally, the stand 270 is configured to pivot relative to main surface 210, e.g., in order to be stowed against the first main surface 210 to enable mounting of the cover 200 to the apparatus 300.

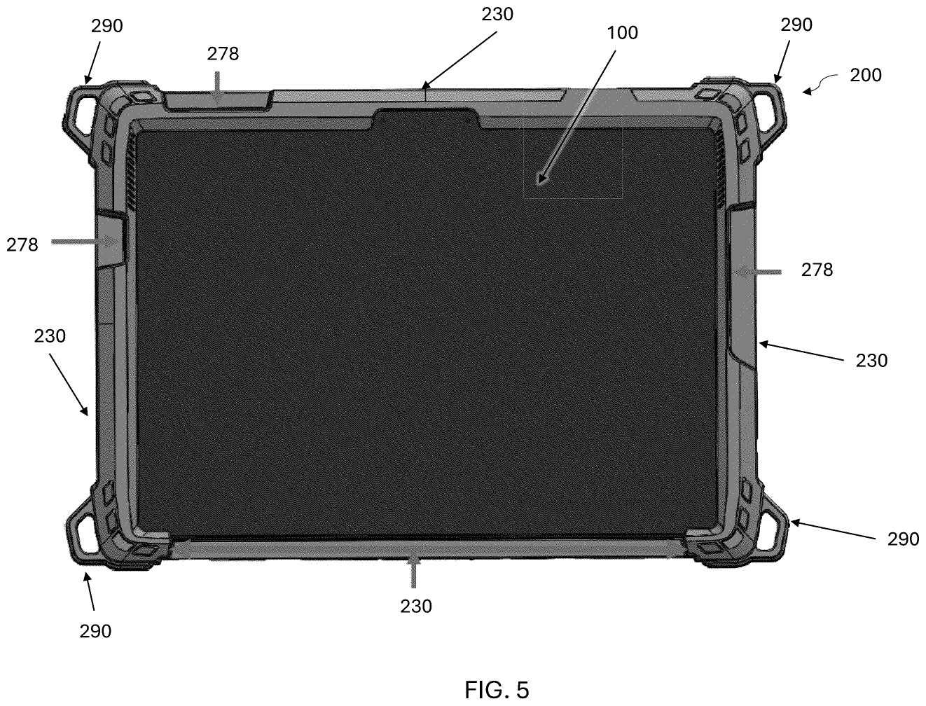

Still further, the cover 200 has one or more peripheral side surfaces 230 at least partially surrounding the first main surface 210. As shown in FIG. 5, the cover 200 is generally rectangular, but is not so limited. Rather, the cover 200 may have any suitable size and shape. Preferably, the mounting surface 200 is configured to have a size and shape that generally corresponds to the size and shape of an object, such as a mobile electronic device, to be received. Although the cover 200 is herein discussed with respect to receiving a mobile electronic device, one skilled in the art would understand from the description herein that other like objects or accessories, such as a laptop or tablet computer, computer display screen, phone, radio communication device, and so on, are within the spirit and scope of the invention.

In an exemplary embodiment, the cover 200 includes bumpers 290. As shown in FIG. 5, Bumpers 290 are positioned at respective corners of the peripheral side surfaces 230. Bumpers 290 may provide fall or impact protection to the mobile electronic device 100 received within cover 200. Bumpers 290 may be integrally formed from the material of cover 200, or may be formed from a separate, elastomer material to provide additional cushioning or impact protection. Bumpers 290 may further be designed to bend or otherwise elastically deform in response to impacts or falls. In the embodiment of FIG. 5, bumpers 290 are formed as protruding loops or hooks of material. This embodiment may be preferred inasmuch as the openings in bumpers 290 may service as attachment points for attaching one or more external accessories (e.g., shoulder straps, clips, lanyards, key rings, etc.) to cover 200. Other suitable attachment points, such as snaps, buttons, clips, etc. will be known from the description herein.

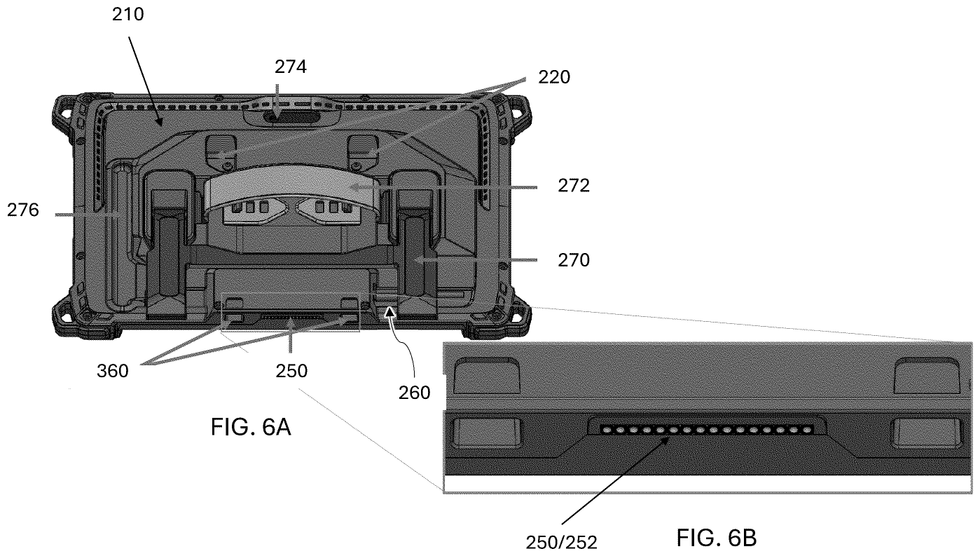

In an exemplary embodiment, the cover 200 includes at least one electrical connector 240 configured to connect with an electrical connector of the mobile electronic device 100. Additionally or optionally, one or more electrical contacts 250 are mounted on at least one of the one or more peripheral side surfaces 230 of the cover 200. The one or more electrical contacts 250 are configured to be in communication with the at least one electrical connector of the mobile electronic device 100. In this way, a suitable mechanical and/or electrical interface between the cover 200 and the mobile electronic device 100 is facilitated via the mounting system 1000. In a non-limiting example, the one or more electrical contacts 250 includes one or more rows of pogo pads 252 (FIG. 6A) formed on the at least one of the one or more peripheral side surfaces 230 (e.g., for connecting a charging cord or display cord to the mobile electronic device 100) housed within the cover 200. As shown in FIG. 6B, pogo pads 252 may be formed flush with the peripheral side surface 230, to simplify mating of electrical contacts 250 to apparatus 300.

In a non-limiting example, as shown in FIG. 9B, an electrical connection to the mobile electronic device 100 housed in the cover 200 is facilitated via at least one electrical receptacle 260 on main surface 210. Electrical receptacle 260 may be oriented at an angle different from and/or orthogonal to electrical contacts 250, as shown in FIG. 9B. Electrical receptacle 260 may be configured to connect with an electrical cable separate from apparatus 300, e.g., receptacle 260 may be a USB-C type receptacle configured to receive a USB cable 400. As shown in FIG. 8, electrical receptacle 260 may be located on a common circuit board 280 with electrical contacts 250. Electrical receptacle 260 may further be in communication with connector 240, in order to enable a separate electrical communication path to mobile electronic device 100. Positioning electrical receptacle 260 on main surface 210 of cover 200 may be desirable in order to enable electrical communication with mobile electronic device 100 when electrical contacts 250 are otherwise inaccessible, e.g., when contacts 250 are covered due to the use of stand 270.

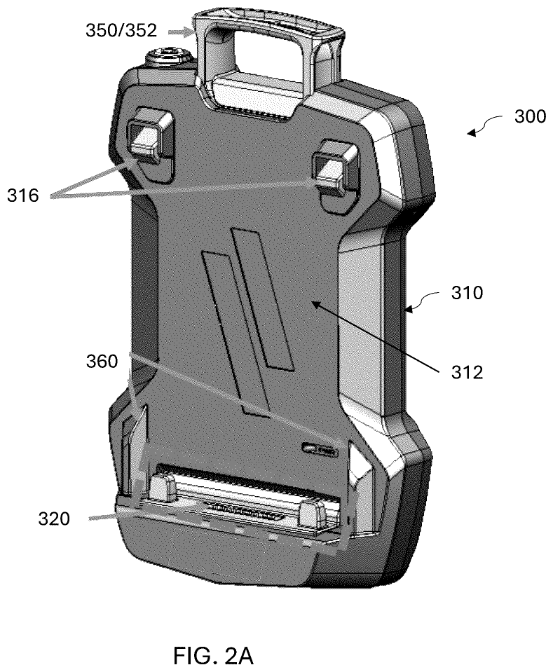

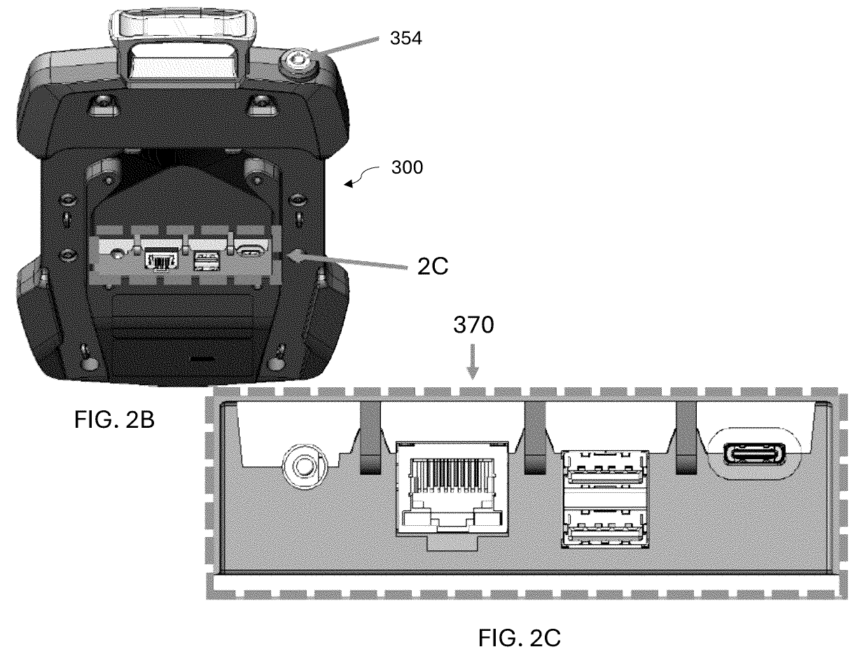

In an exemplary embodiment, the system 1000 includes the apparatus 300 for mounting the mobile electronic device 100 received within the cover 200. As shown in FIGS. 2A-2C, the apparatus 300 includes a base 310 and a docking connector 320 coupled to the base 310. The base 310 has sufficient rigidity and strength to securely fix one or more different types of objects or accessories, including the mobile electronic device 100 housed within the cover 200. For example, the base 310 may comprise a metal or rigid polymer part. The load-bearing capacity of the base 310 preferably is selected to hold the largest compatible object without substantial movement during normal operation and movement of the object. Persons or ordinary skill in the art will understand how to design the base 310 to obtain the desired rigidity and strength based on known engineering principles, which need not be explained in detail herein.

In a non-limiting example, the base 310 is a single unitary part, or it may be an assembly of structural elements comprising multiple individual unitary parts. For example, the base 310 may be an assembly of parts including a mounting surface 312 configured to face the first main surface 210 of the cover 200 and a docking surface 314 projecting from and fixedly coupled to the mounting surface 312. The mounting surface 312 of has one or more latches 316 configured to mate with the one or more latching points 220 of the cover 200. The mounting surface 312, the docking surface 314, and the one or more latching latches 316 may be connected to each other using any suitable fasteners or combinations of fastening means, such as screws, nuts and bolts, rivets, welding, adhesives, and so on. The various parts of the base 310 may be formed using any suitable materials. For example, one or more of the parts may comprise sheet metal, cast metal, or machined metals parts. Steel and aluminum are considered to be suitable materials, but other materials, such as carbon fiber reinforce plastics or other composite materials may be used. Unreinforced structural plastics also may be used. Folded sheet metal is preferred for its low cost and high strength, but injection molded plastics, or cast or machined metal parts may be desirable to accommodate particularly complex shape requirements or reduce weight or part count.

Additionally or optionally, the mounting surface 310 may have any suitable size and shape. Preferably, the mounting surface 310 is configured to have a size and shape that generally corresponds to the size and shape of at least the cover 200 configured to receive the mobile electronic device 100. Further, the mounting surface 312 has a generally planar surface and/or is configured to substantially contact or face the first main surface 210 of the cover 200. Also, the docking surface 314 is configured to face the at least one of the one or more peripheral side surfaces 230 of the cover 200.

In an exemplary embodiment, the apparatus 300 includes a docking connector 320 coupled to the docking surface 314. Additionally or optionally, the docking connector 320 is movable relative to the docking surface 314 between a first position and a second position. In a non-limiting example, the apparatus 300 includes one or more biasing elements in order to bias the docking connector 320 toward the first position. As with the base 310, the docking surface 314 may include a single unitary part, or it may be an assembly of structural elements comprising multiple individual unitary parts. For example, the docking surface 314 may include a docking platform 340 which is pivotable relative to the docking surface 314, thereby moving the docking connector 320 between the first and second positions. Additionally or optionally, the docking platform 340 includes a stop surface 330 positioned to engage a portion of the docking surface 314 when the docking connector 320 is in the first position.

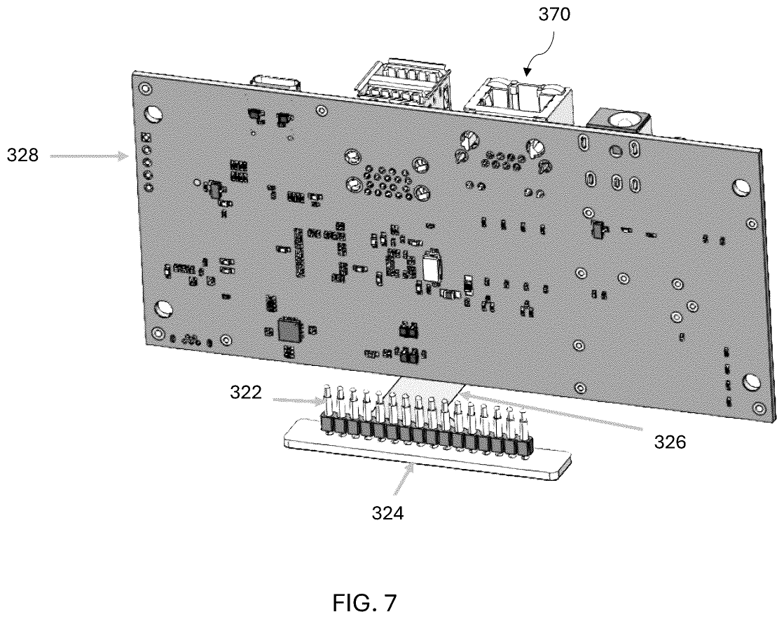

Further, the docking connector 320 is configured to electrically connect with the one or more electrical contacts 250 of the cover 200. FIG. 7 depicts an example of the internal electronics of apparatus 300. As shown in FIG. 7, docking connector 320 includes electrical contacts 322. In this example, contacts 322 are formed as pogo pins which are aligned and configured to electrically contact with the pogo pads 252 on the peripheral side surface 230 of cover 200. Contacts 322 may be mounted on a board or other stiff material 324 configured to support the position and arrangement of the contacts. Contacts 322 of docking connector 320 are also electrically connected with one or more electrical connections 370 provided on a rear surface of base 310, e.g., via electrical conductor 326. In this way, apparatus 300 may enable electrical connections from mobile device 100 through electrical connector 240, the one or more electrical contacts 250 of cover 200, the electrical contacts 322 of docking connector 320, electrical conductor 326, and then to an associated vehicle or other device via electrical connections 370.

As shown in FIG. 7, electrical connections 370 for interfacing apparatus 300 to an external system or device (e.g., a vehicle) may all be mounted on a common circuit board 328. Suitable categories and sizes of electrical connections 370 may be selected based on the systems to which it is desired to interface apparatus 300, and will be apparent from the description herein.

The apparatus 300 may additionally or optional include at least one actuator 350 configured to disengage the one or more latches 316 of the apparatus 300 from the one or more latching points 220 of the cover 200. In a non-limiting example, the actuator 350 includes a handle 352 coupled to a region of the base 310 opposite the docking surface 314. Actuator 350 may further include a lock 354 configured to restrict actuation of handle 352. In this way, apparatus 300 can prevent unauthorized removal of mobile device 100 received in cover 200.

During mounting of mobile device 100 received in cover 200, docking connector 320 is initially electrically connected with the one or more electrical contacts 250 of the cover 200. At this first point of contact, the first main surface 210 of the cover 200 is positioned obliquely relative to the mounting surface 312 of the base 310 in the first position of the docking connector 320. Subsequently, the first main surface 210 of the cover 200 is moved until it is aligned in contact with the mounting surface 312 of the base 310 in the second position of the docking connector 320, such that the one or more latches 316 mate with the one or more latching points 220 of the cover 200.

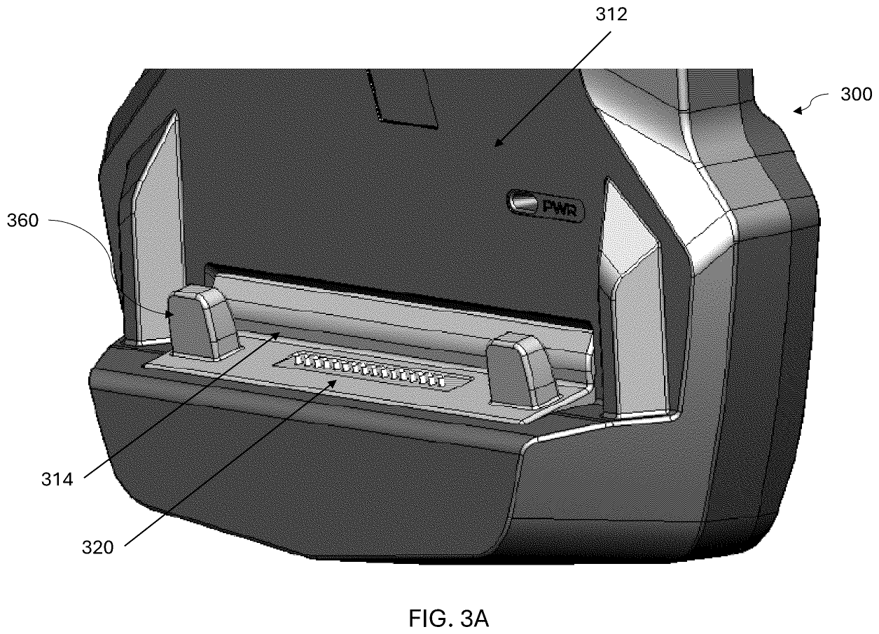

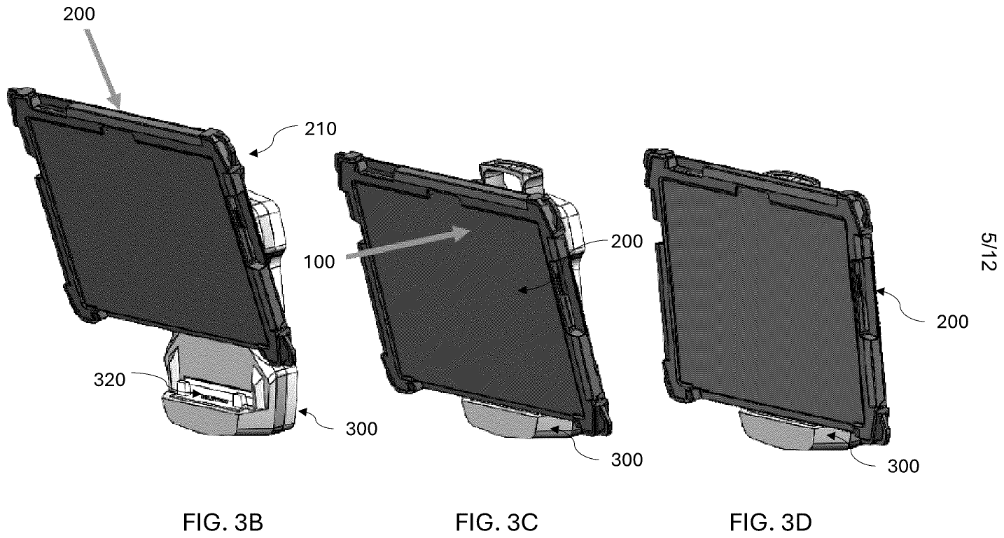

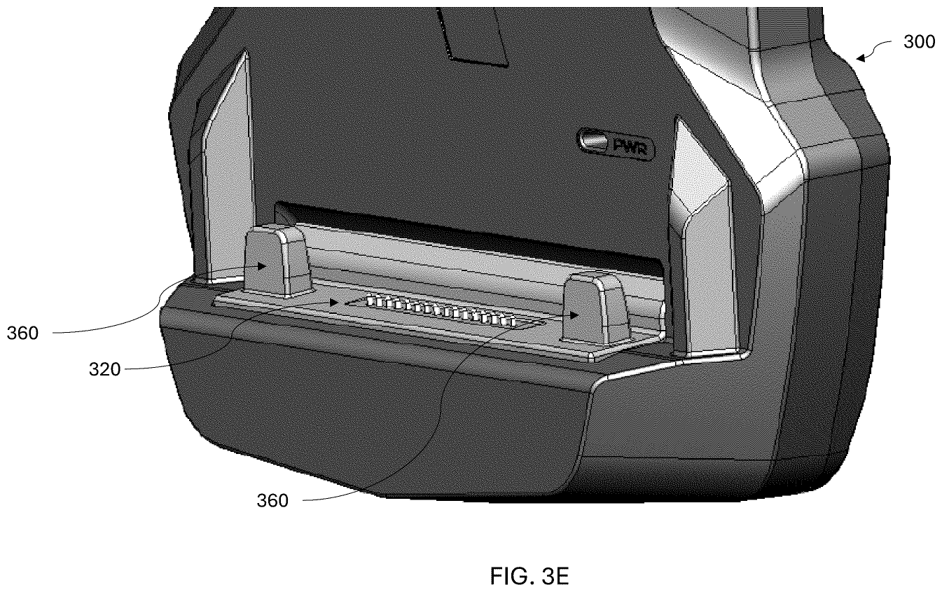

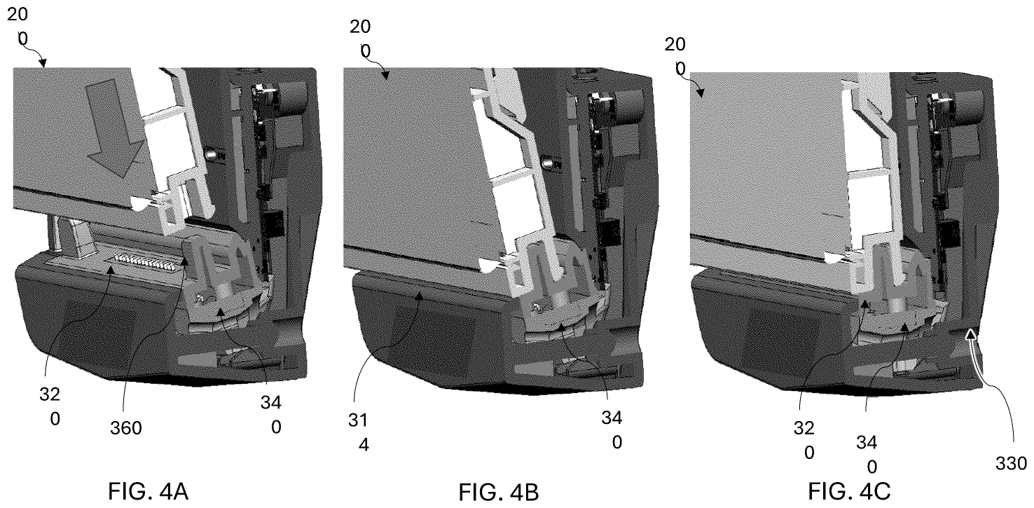

Turning now to FIGS. 3A-3E and 4A-4C, an exemplary docking sequence for mounting the mobile electronic device 100 received within the cover 200 on the apparatus 300 is provided below. As seen in FIG. 3A, when the one or more electrical contacts 250 of the cover 200 are connected to the docking connector 320 of the apparatus 300 and the docking connector 320 is in the second position, or the docked position, the first main surface 210 of the cover 200 is configured to be positioned obliquely relative to the mounting surface 312 (i.e., at an angle relative to mounting surface 312). As seen in FIG. 3E, when the one or more electrical contacts 250 of the cover 200 are connected to the docking connector 320 and the docking connector 320 is in the second position, or docked position, the first main surface 210 of the cover 200 is configured to be aligned in contact with the mounting surface 312 (i.e., at an angle parallel to and/or in contact with mounting surface 312). Additionally or optionally, alignment of the cover 200 against the mounting surface 312 of the base 310 is guided by one or more alignment features 360 configured to mate with corresponding projections or recesses of the cover 200 to align the cover 200 with the base 310 during mounting. As shown in FIGS. 3E and 4A, alignment features 360 may include a pair of projections at opposed ends of docking connector 320 which are configured to make initial contact with cover 200, and thereby guide cover 200 during mounting to apparatus 300, thereby ensuring proper electrical contact between one or more electrical contacts 250 and the electrical contacts of docking connector 320. A person of ordinary skill in the art would understand from the description herein that the one or more alignment features 360 may have any suitable size and shape, such that one or more alignment features 360 mate with corresponding projections or recesses of the first main surface 210 of cover 200 to firmly and reliably guide mating of the cover 200 housing the mobile electronic device 100 with the base 310 of the apparatus 300. Other alternatives and variations of the alignment features 360 will be apparent to persons of ordinary skill in the art in view of the present disclosure.

In FIGS. 3B and 4A, the cover 200 housing the mobile electronic device 100 is lowered towards the docking connector 320 of the apparatus 300. In FIGS. 3C and 4B, an application of force or pressure to at least one of the peripheral side surfaces 230 of the cover 200 facilitates the mating of the one or more latches 316 of the apparatus 300 with the one or more latching points 220 of the cover 200. In FIGS. 3D and 4C, the docking connector 320 is in the second position, or the docked position, in which the cover 200 housing the mobile electronic device 100 is mounted or secured to the base 310 of the apparatus 300. As stated above, the movement of the docking connector 320, such as movement between the first and second positions, is facilitated by one or more biasing elements. For example, the one or more biasing elements facilitate movement of the docking connector 320 between the first position and the second position. In a non-limiting example, the docking platform 340 is configured to be pivotable relative to the docking surface 314 and thus guides movement of the docking connector 320 between the first position and the second position.

Although the invention is illustrated and described herein with reference to specific examples, the invention is not intended to be limited to the details shown. Rather, various modifications may be made in the details within the scope and range of equivalents of the claims and without departing from the invention.

1. A mounting system for a mobile electronic device comprising:
a cover configured to house the mobile electronic device, the cover comprising
a first main surface comprising one or more latching points;
one or more peripheral side surfaces at least partially surrounding the first main surface;
at least one electrical connector configured to connect with an electrical connector of the mobile electronic device; and
one or more electrical contacts mounted on at least one of the one or more peripheral side surfaces, the one or more electrical contacts in communication with the at least one electrical connector; and
an apparatus for mounting the mobile electronic device received within the cover, the apparatus comprising:
a base comprising a mounting surface configured to face the first main surface and a docking surface projecting from and fixedly coupled to the mounting surface, the mounting surface comprising one or more latches configured to mate with the one or more latching points, the docking surface configured to face the at least one of the one or more peripheral side surfaces of the cover;
a docking connector coupled to the docking surface, the docking connector configured to electrically connect with the one or more electrical contacts of the cover, the docking connector movable relative to the docking surface between a first position and a second position;
wherein when the docking connector is electrically connected with the one or more electrical contacts, the first main surface of the cover is positioned obliquely relative to the mounting surface in the first position of the docking connector, and the first main surface of the cover is aligned in contact with the mounting surface in the second position of the docking connector, such that the one or more latches mate with the one or more latching points.

2. The mounting system of claim 1, wherein the apparatus comprises one or more biasing elements in order to bias the docking connector toward the first position.

3. The mounting system of claim 1, wherein the docking connector is mounted on a docking platform, the docking platform being pivotable relative to the docking surface to move the docking connector between the first and second positions.

4. The mounting system of claim 3, wherein the docking platform further includes a stop surface positioned to engage a portion of the docking surface when the docking connector is in the first position.

5. The mounting system of claim 1, wherein the apparatus comprises at least one actuator configured to disengage the one or more latches from the one or more latching points.

6. The mounting system of claim 5, wherein the actuator comprises a handle movably coupled to the base.

7. The mounting system of claim 6, further comprising a lock configured to restrict actuation of the handle.

8. The mounting system of claim 1, wherein the first main surface of the cover comprises at least one electrical receptacle separate from the one or more electrical contacts.

9. The mounting system of claim 8, wherein the at least one electrical receptacle is in communication with the at least one electrical connector.

10. The mounting system of claim 8, wherein the at least one electrical receptacle is mounted on a common circuit board with the one or more electrical contacts.

11. The mounting system of claim 1, wherein one or more electrical contacts comprise one or more rows of pogo pads formed on the at least one of the one or more peripheral side surfaces.

12. The mounting system of claim 11, wherein the one or more rows of pogo pads are positioned flush with the at least one of the one or more peripheral side surfaces.

13. The mounting system of claim 1, wherein the first main surface of the cover comprises a stand in order to maintain the mobile electronic device in an upright or tilted position.

14. The mounting system of claim 13, wherein the stand is configured to be stowed against the first main surface to enable mounting of the cover to the apparatus.

15. The mounting system of claim 1, wherein the cover comprises a plurality of bumpers positioned at respective corners of the one or more peripheral side surfaces.

16. The mounting system of claim 15, wherein one or more of the plurality of bumpers comprises an attachment point for attaching one or more accessories to the cover.
